(19) United States
(12) Patent Application Publication
(10) Pub. No.: US 2006/0072637 A1
(43) Pub. Date: Apr. 6, 2006

(54) Controller for operating a portable lighting device

(76) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(21) Appl. No.: 11/227,925

(22) Filed: Sep. 14, 2005

Related U.S. Application Data
(60) Provisional application No. 60/615,234, filed on Oct. 1, 2004.

(51) Int. Cl. H01S 3/04

(52) U.S. Cl. 372/36

(57) ABSTRACT

Embodiments of the invention offer multiple modes of portable light power control with a single momentary switch. In some embodiments, when the switch is pressed and held on, the laser operates in momentary mode and is active until the switch is released. If the switch is pressed and then immediately released, then pressed again and again immediately released, the laser will function under latching mode and stay on until the switch is pressed again to turn off the laser. Further, in some embodiments, if the switch is pressed three times in succession, the laser enters timed mode and will stay on for a predetermined duration, fifteen minutes for example. Different sequences of switch presses could be configured to cause the light source to be placed in various operation modes.

### CROSS REFERENCE TO RELATED APPLICATIONS

This application claims priority from U.S. Provisional Application No. 60/615,234, filed on Oct. 1, 2004, entitled CONTROLLER FOR LASER DEVICE, the contents of which are herein incorporated by reference for all purposes.

### TECHNICAL FIELD

This disclosure relates to a light generating device controller, and, more particularly, to a multiple-function controller used in a laser device.

### BACKGROUND OF THE INVENTION

This disclosure describes a way to provide a cost-effective multi-mode power control mechanism for a portable laser or other lighting device while utilizing only a single control switch. Portable lasers are popular for use in classrooms and lectures as a pointing device. The presenter simply points at the area of a picture or a document that he wishes to emphasize and the laser beam creates a bright spot at that location that is easily visible to audience members.

Portable lasers, particularly those of green color, are also useful as a night sky pointers because the beam is easily visible as it travels through the sky.

Conventional portable lasers are typically equipped with a single switch to control power. Many portable lasers utilize a momentary switch for power control. An example is the Leadlight Inc. model AGPLG3-105. Its laser beam is on only for as long as the switch is pressed and immediately turns off when the switch is released.

Another common type of power control is the Leadlight AGPLG1-105 which uses a latching power switch. Press the switch once and the laser beam turns on and stays on until the switch is pressed again.

Yet another type of power control is timed operation. A single switch press causes the laser beam to energize for a specific time period, fifteen minutes for example, and then turn off again.

Although these types of switches are useful, none provides the level of control desirable for a fully functional light controller.

Embodiments of the invention address these and other limitations of the prior art.

### BRIEF DESCRIPTION OF THE DRAWINGS

FIG. 1 is a functional block diagram of a controller according to embodiments of the invention.

FIG. 2 is an example flow diagram illustrating methods according to embodiments of the invention.

FIG. 3 is an example flow diagram illustrating additional methods according to embodiments of the invention.

### SUMMARY OF THE INVENTION

Embodiments of the invention offer multiple modes of portable laser power control with a single momentary switch. In some embodiments, when the switch is pressed and held on, the laser operates in momentary mode and is active until the switch is released. If the switch is pressed and then immediately released, then pressed again and again immediately released, the laser will function under latching mode and stay on until the switch is pressed again to turn off the laser. Further, in some embodiments, if the switch is pressed three times in succession, the laser enters timed mode and will stay on for a predetermined duration, fifteen minutes for example.

### DETAILED DESCRIPTION OF THE PREFERRED EMBODIMENTS

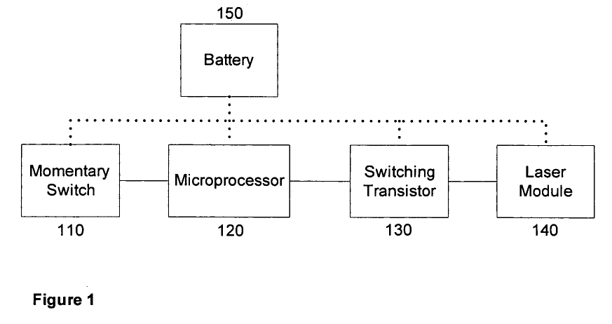

Embodiments of the invention provide a convenient way to control power to a portable laser using only a single switch. FIG. 1 is a block diagram of a preferred embodiment. In FIG. 1, a momentary switch 110 is connected to a microprocessor 120 which controls power to a laser module 140 through a switching transistor 130. The system is powered by a power supply, which is typically a battery 150.

In preferred embodiments, the momentary switch 110 is mechanical and operates by electrically shorting two conductive contacts together. Other embodiments could use other types of switches including those of capacitive, magnetic or optical function. All switch technologies are anticipated by this invention.

In a preferred embodiment the switching transistor 140 is a Zetex Corporation ZXM61N03FTA N Channel MOSFET, although other devices may be equally effective. The switching transistor can also be built into the microprocessor 120 or implemented with a standard PNP or NPN transistor, a relay or other electrical control switch. Such alternative devices are well known to those skilled in electronic design.

In a preferred embodiment, the microprocessor 120 is a Microchip Technologies Corp. PIC12CRJ09A. This microprocessor has a small size and relatively low cost. Other microprocessors could also be employed with equal effectiveness. As is well known to electronic designers, the microprocessor 120 could also be replaced with discrete logic or logic implemented in a Programmable Gate Array or Application Specific Integrated Circuit (ASIC).

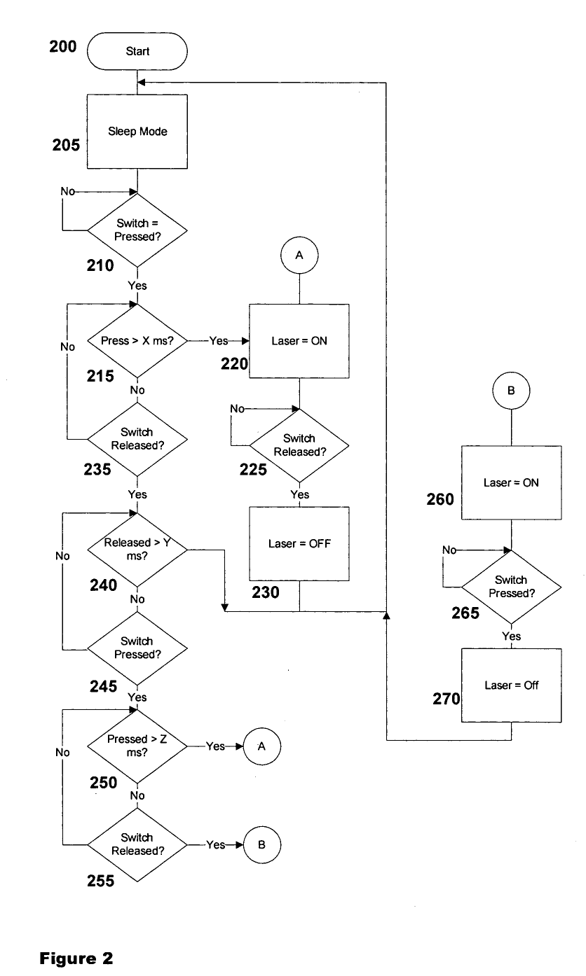

FIG. 2 is an example flow diagram of methods according to embodiments of the invention. Operation begins at 200 and the microprocessor 130 enters low power sleep mode at process 205. If a switch press detection occurs in a process 210, the duration of the switch press is measured to see if it exceeds X time (typically measured in milliseconds) in the process 215. If true, operation flow continues to a process 220, where the flow mimics a traditional momentary switch. The laser is turned on in the process 220, and the switch is monitored in a process 225 until it is released. When the switch is released, the laser is turned off in a process 230 and the flow loops back to the sleep mode process 205.

Returning back to process 215, if the switch has been pressed for less than X time, the switch is tested to see if it has been released in a process 235. If it has not, the pressed time continues to be measured and the process 215 again compares the pressed time to the predetermined time X.

If the switch is released before exceeding X time in the process 235, the release duration is measured to see if it has lasted for more than Y time (typically measured in milliseconds) in a process 240. If the release time is greater than Y, the switch press was presumed to be in error and sleep mode is re-entered in the process 205.

If the release time as measured in the process 240 has not exceeded Y time, the flow tests for a new switch press in a process 245. If no subsequent press has occurred, this loop between processes 240 and 245 repeats until either the switch is again pressed or the release time exceeds Y time.

If the switch is again pressed before the release time has exceeded Y time in the process 245, the second press duration is measured in a process 250. If this second switch press has lasted more than Z time (typically measured in milliseconds), the first switch press of less than X time is disregarded and momentary switch operation is emulated. As described above, in this situation the laser is turned on in the process 220 and stays on until the switch is again released in the process 225. At that time, the laser is turned off in the process 230 and again enters sleep mode in the process 205.

If the second switch press has not lasted more than Z time as determined by the process 250, the switch is tested to see if it has been released in the process 255. If it has not, the switch press time is again measured in the process 250 and this loop between processes 250 and 255 is repeated until the switch press exceeds Z time or the switch is released.

If the process 255 determines that the switch is released prior to the switch press time exceeding Z time, the latching mode begins. In such a mode, the laser is turned on in a process 260 and stays on until the switch is again pressed in a process 265. When the process 265 determines that the switch was pressed the second time in the latch mode, the laser turns off in a process 270 and the flow loops again to the sleep mode of process 205.

The time durations X, Y and Z may be set to the same or different values. A preferred embodiment configures times X and Z at between 50 and 1,000 milliseconds and more preferably 350 milliseconds each, and time Y at between 50 and 1,000 milliseconds and more preferably 500 milliseconds, though other durations are useful in certain circumstances and are anticipated by this invention. Each duration is chosen to provide a pleasing operational feel to the user. If X time is too short it may be difficult for the user to enter latching mode. If X time is too long, the user may dislike how long it takes to begin operation in momentary mode.

The Y time duration should be long enough to allow a second press, but not so long as to allow inadvertent entry into latching mode because of a mistaken first switch press. The Z time duration is preferably configured at the same value as X, but could be made longer or shorter in duration as user needs dictate. Variations of the above described operation are anticipated by this invention, as embodiments of the invention are operable with many different time periods, and no particular time periods are required.

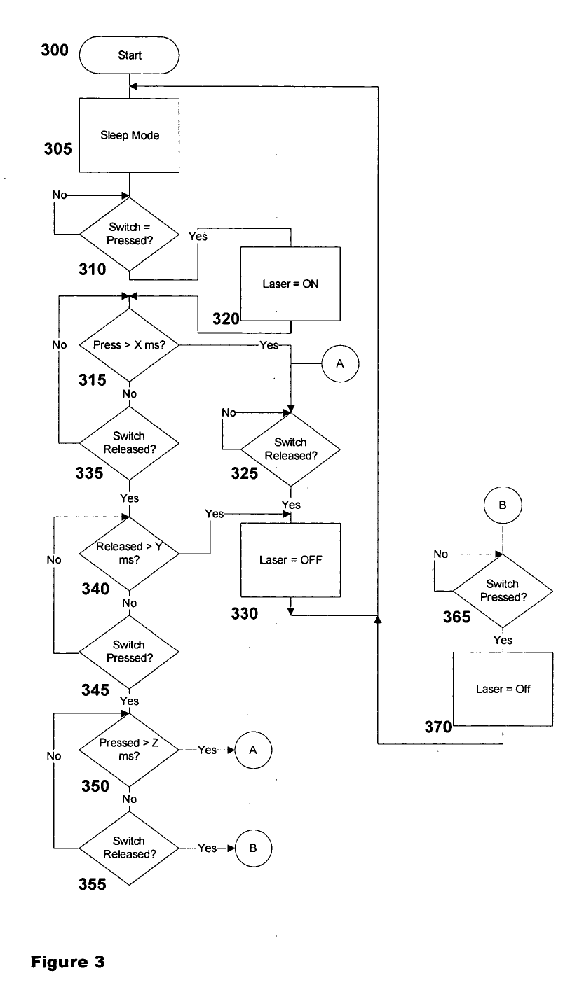

FIG. 3 is an example flow diagram illustrating other methods of operation according to embodiments of the invention. In this embodiment, the laser is immediately turned on upon the first switch press and stays on during the multiple presses required to specify the latching mode of operation. This offers the benefit of instantaneous laser operation as opposed to the delay of X time in the previously described embodiment.

The flow illustrated in FIG. 3 begins at 300 and the microprocessor 130 enters low power sleep mode at a process 305. If switch press detection occurs in a process 310, the laser module 140 (FIG. 1) is turned on in a process 320, and the duration of the switch press is measured to see if it exceeds X time in a process 315. The times “X”, “Y”, and “Z” of FIG. 3 need not be the same as described above with reference to FIG. 2. If the output of the process 320 is true, the laser operation is implemented to mimic a traditional momentary switch. In such a mode, the switch is monitored until it is released at a process 325 at which time the laser is turned off in a process 330 and the sleep mode is re-entered in the process 305.

If the switch has been pressed for less than X time as determined by the process 315, the switch is tested to see if it has been released in a process 335. If it has not, the pressed time continues to be measured in the process 315 and this loop repeated.

If the switch is released before exceeding X time in a process 335, the release duration is measured to see if it has lasted for more than Y time in a process 340. If it has, the laser is turned off in a process 330 and sleep mode is re-entered in the process 305.

If the release time as measured by the process 340 has not exceeded Y time, it is tested for a new press in a process 345. If no press has occurred, this loop between processes 340 and 345 is repeated until either the switch is again pressed or the release time exceeds Y time.

If the switch is again pressed before the release time has exceeded Y time in the process 345, the second press duration is measured in a process 350. If this second switch press has lasted more than Z time, the laser stays on only until the switch is again released in the process 325 at which time the laser is turned off in the process 330 and sleep mode again entered in a process 305.

If the second switch press has not lasted more than Z time in the process 350, the switch is tested to see if it has been released in a process 355. If it has not, the switch press time is again measured in the process 350, and this loop is repeated until the switch press exceeds Z time or the switch is released.

If the switch is released in the process 355 prior to the switch press time exceeding Z time, the latching mode begins. The laser stays on until the switch is again pressed in a process 365, at which time the laser is turned off in a process 370 and the sleep mode is re-entered in the process 305.

Another variation that could apply to either FIG. 2 or FIG. 3 methods of operation is to remain in latch mode until the switch is again pressed and released. Yet another variation adds a timed laser operation that is begun after three successive switch presses and releases within specified time periods. In this variation, a single press triggers momentary mode, two quick presses undertakes latched mode and three quick successive presses undertakes timed mode in which the laser is turned on and remains on until D duration of time has passed. One preferred duration of D is 15 minutes though other time durations are possible. The microprocessor 120 could detect the switch presses and implement the appropriate modes.

The timed operation could be forced to last for the entire time or allow the user to turn of the laser within the defined time by once again pressing the switch. The laser could be turned off on at switch press or switch release.

Additional successive quick switch presses could be added to implement other functions. For example, the laser could enter latched mode on the second press, a timed operation on the third press or a longer timed operation on a fourth press. Any number of quick successive switch presses are anticipated. The minimum duration of each press and the maximum allowable time between each press can be of any length.

Any function can be assigned to any string of quick key presses. For example, a two press sequence could activate 30 a minute timed mode while a three press sequence could activate a latch mode and a four press sequence could activate a 15 minute timed mode.

Another variation is a delayed turn off time. A series of two quick presses, for example, could cause the laser to latch on. The next switch press could end the latch mode and turn the laser off, but only after a predefined period of time passed. This would be useful when a portable laser is mounted on a telescope and used for aligning the telescope with a desired astronomical object. The latched mode lets the user make approximate alignment. When that is accomplished, the user again presses the laser switch which activates the timed off mode. In such an embodiment, the user then has X seconds to make final alignment through the eyepiece of his telescope and the laser will turn off automatically without the user having to touch the laser or telescope, which could otherwise potentially cause telescope shaking or misalignment.

While the above description refers to lasers, the same control mechanism from a single switch could apply equally to flashlight, LED array or other portable lighting system.

1. A method for operating a portable lighting device having a switch for controlling a light on the device, the method comprising:
turning the light on in a first mode by pressing the switch and leaving the light on for so long as the switch is pressed;
turning the light off in response to switch action;
turning the light on in a second mode by pressing the switch twice within a predetermined time period;
leaving the light on when the switch is released; and
turning the light off in response to further switch action.

2. The method of claim 1 wherein turning the light on in the first mode occurs substantially simultaneously with pressing the switch.

3. The method of claim 1 wherein turning the light on in the second mode occurs substantially simultaneously with the second press of the switch.

4. The method of claim 1 wherein turning the light on in the first mode occurs within a predetermined delay after pressing the switch.

5. The method of claim 1 wherein turning the light on in the second mode occurs within a predetermined delay after the second press of the switch.

6. The method of claim 1 wherein further switch action comprises pressing the switch.

7. The method of claim 1 wherein further switch action comprises pressing and releasing the switch.

8. The method of claim 1 wherein the method further comprises turning the light on in a third mode by pressing the switch three times within a predetermined time period.

9. The method of claim 8 wherein the third mode comprises leaving the light actuated for a predetermined time period.

10. The method of claim 9 wherein the method further comprises turning the light off in response to switch action prior to the end of the predetermined time period.

11. The method of claim 8 wherein the method further comprises turning the light on in a fourth mode by pressing the switch four times within a predetermined time period.

12. The method of claim 9 wherein the method further comprises turning the light on in a fourth mode by pressing the switch four times within a predetermined time period.

13. The method of claim 12 wherein the fourth mode comprises leaving the light actuated for a second predetermined time period.

14. The method of claim 1 wherein turning the light off in response to further switch action comprises turning the light off after a predetermined delay initiated by the further switch action.

15. A computer readable medium containing a program executable on a computer system to implement the method of claim 1.

16. A method for implementing a portable light source comprising:
providing a switch;
creating a plurality of switch codes that are each defined by a different number of switch actions; and
associating one switch code with a momentary switch light mode in which the light is on substantially all of the time the switch is depressed and off substantially all of the time the switch is released and associating another switch code with a latch light mode in which the light remains on even when the switch is not depressed and is turned off responsive to further switch action.

17. The method of claim 16 wherein the method further comprises associating a third switch code with a timed light mode in which the light remains actuated for a predetermined time period after switch actuation.

18. A portable light source implemented in accordance with the method of claim 16.

19. A portable light source comprising:
a light;
a switch for turning the light on and off responsive to switch action;
a memory that stores criteria for identifying different switch action codes;
a controller that monitors switch action and responsive to a first code turns the light on in a first mode in which the light is on substantially all of the time the switch is depressed and off substantially all of the time the switch is released, and responsive to a second code turns the light on in a second mode in which the light remains on when the switch is not depressed and is turned off responsive to further switch action.
